(19) United States
(12) Patent Application Publication
(10) Pub. No.: US 2006/0000044 A1
(43) Pub. Date: Jan. 5, 2006

(54) Windscreen wiper comprising a mobile double wiper

(75) Inventor: Emmanuel Garcia de La Peña Razquin, Zaragoza (ES)

Correspondence Address: Kramer & Amado, Suite 240, 1725 Duke Street, Alexandria, VA, 22314, US

(73) Assignee: LEUNAMME ENGINEERING, S.L., Zaragoza (ES)

(21) Appl. No.: 10/526,070

(22) PCT Filed: Aug. 22, 2003
(86) PCT No.: PCT/ES03/00434

§ 371 Date: Feb. 28, 2005

(30) Foreign Application Priority Data
Aug. 31, 2002 (ES) P200202002

(51) Int. Cl. B60S 1/28; B60S 1/38; B60S 1/46

(52) U.S. Cl. 15/250.04; 15/250.4; 15/250.41; 15/250.201

(57) ABSTRACT

Dual movable blade windshield wiper, composed by an additional blade made of dirt-abrasive (insect remains, dirt of birds or other kind of difficult cleaning dirt) and glass-scratch-free material, that only touches the windshield when it wants to be cleaned and a electro-mechanical device activated from the driver seat, that locates the additional blade in contact with the windshield and removes it once the cleaning is finish.

The aim of this invention called “Dual movable blade windshield wiper” is to optimise the automatic cleaning of the car windshields in driving condition.

In particular the known and unsolved problem of cleaning insect remains after its impact against the windshield.

### STATE OF THE ART

After analysing the information shown in the International Search Report the following can be stated:

Closest Prior art can be considered the Patent ES 486615, this patent from 1978 discloses a wiper system with an additional movable blade actuated by a cylinder on top of it. Such a device nowadays is cosmetic wise un saleable and its functionality questionable due to the high inertia that such a weight would incorporate to the wiper movement.

Patent U.S. Pat. No. 3,192,551 (not mentioned in the search report) is the prior art for the version described in page 3 lines 24-26.

Patents U.S. Pat. Nos. 5,168,595, 5,301,384 and 5,442,834 are only considering a rotating movement operated by a bowden cable or motor, which is not claimed in this patent.

Patents GB 2106775 and U.S. Pat. No. 4,719,661 have nothing to do with this invention. Despite of disclosed prior, art the product described below in detail presents enough differences with those patents and with current existing products to enable us to consider it with novelty, inventive sep and industrial applicability.

### DESCRIPTION

The present invention consists in incorporating to conventional wipers an additional blade composed of abrasive material with insect remains (or any other kind of dirt like: dirt from trees—when you park under it-, dirt of trucks, dirt of birds, frost, etc) and not abrasive (scratch resistant) with glass. Blade can be reversible having ice scratcher in one face and scourer on the other. This kind of materials are available in the market, as sponges, scratch free plastic and no plastic scourers, brushes like the ones used on toothbrush, WC brushes, etc.

This additional blade has movement, in the sense that it has only contact with the windshield when the user wants to make the cleaning function. At the same, time the arm makes more force to increase the pressure against the windshield. It means that in regular rain conditions, with the standard wiper working, only the standard rubber blade is in contact with the windshield.

The additional blade could be exchanged by a spare part when deteriorated by usage and its function it is not good.

Due to cosmetic and cost reasons this additional blade would be integrated into the wiper spoiler.

The cleaning function would be composed of several cycles where the water nozzles and the additional blade would be activated with a higher pressure against the windshield during a number of loops. After this, the conventional blade would return to contact the windshield, to remove the water and the adrift remains from the windshield, leaving it clean as when you perform it manually in a Gas Station, since basically, it makes in automatic mode the same cleaning process.

The present invention considers two variants:

1. The additional blade approaches the windshield rejecting the conventional rubber blade with a parallel movement to the conventional blade.

2. The additional blade approaches the windshield rejecting the conventional rubber blade with a rotation which axle is parallel to both blades.

### DRAWING DESCRIPTION

Variant 1

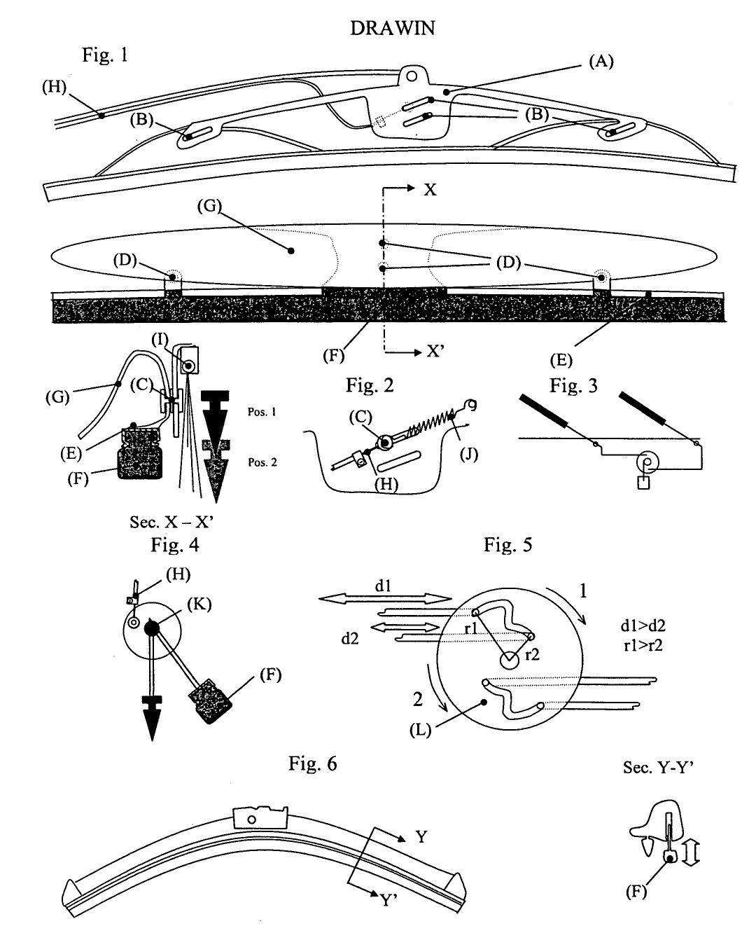

In FIG. 1 it can be seen slotted holes in angle (B) in the conventional blade holder (A). The plastic or metallic rivets (C) that are fixed to the holes (D) from the assembly spoiler-additional blade holder-additional blade (E-F-G) are sliding along the mentioned slotted holes (B). In section X-X′ it can be seen how the holder (E) from the additional blade (F) integrates the spoiler (G) as well as the position of the additional blade during the cleaning operation (Pos. 1) and the normal function with rain (pos. 2)

In FIG. 2 it can be seen how the movement of the additional blade (F) is achieved by the pulling of the rivets (C) from the assembly (E-F-G) by a bowden cable or nylon wire (H), which is activated by an electrical motor. The assembly also incorporates a spring (J) that helps to reject the blade (F) from the windshield.

The bowden cable (H) is routed along the wiper arms (see FIG. 1), goes through the car cowl towards the plenum chamber, where the motor is located integrated into the wiper linkage assembly (see FIG. 3). The motor can also be located in the holder (A), in this case no bowden cable would be needed.

Variant 2

In FIG. 4 it can be seen how in this variant the contact of the abrasive blade is achieved by the rotation following a longitudinal axis (K).

Said rotation can be achieved in two ways:

1. Operating a bowden cable (H) with a motor as in variant 1.

2. Modifying the wiper travel (d) when the cleaning function is activated. With a cam-disk (L) as the one drawn in FIG. 5, a longer travel (d1) can be achieved by inverting the rotation sense of the wiper motor of the wiper arms when going in sense 1. By increasing the travel, the wiper touches an end-of-travel stop located in the lower area of the windshield, which makes a turn in the axis (K) producing the exchange of blades. When the other extreme of the travel is reached (the wiper is in vertical position), the wiper touches again other end-of-travel and moves to the conventional blade back. In this way the wiper goes up with the abrasive blade and down with the rubber one.

In both variants, conventional nozzles located in the hood or in the cowl can apply the washing liquid. Nevertheless, to improve the performance of the abrasive blade, it is advisable to have the nozzles (I) located between the conventional and the abrasive blade with several nozzles spread along the whole length. (see section X-X′ in FIG. 1).

Both variants are applicable in the new rising technology of standard blades hold by a bended metal band. In this cases, due to the non presence of a spoiler, the additional blade is integrated in the assembly composed by the metal band and its housing (see FIG. 6)

1. Dual movable blade windshield wiper, composed by a conventional rubber blade and an additional one, made of dirtiness abrasive and glass non abrasive material, where said additional blade only touches the windshield when a deep cleaning function is activated, characterized by that said additional blade is moved in a parallel plane to the conventional blade or rotating by a parallel axel to the conventional blade when activated, its activation is done via reversing the wiper motor direction to increase the arm travel (see FIG. 5), doing this, the wiper reaches a stop at the end of travel of the wiper arm, which releases a latch that exchanges the blades, said motor reversing is activated by a switch at the driver seat controls.

2. Dual movable blade windshield wiper, composed by a conventional rubber blade and an additional one, made of dirtiness abrasive and glass non abrasive material, where said additional blade only touches the windshield when a deep cleaning function is activated characterized by that said additional blade is moved in a parallel plane of the conventional blade when pulled or pushed by a bowden cable, wire or rod that transmits the movement of a motor located at the other end (FIG. 6), said motor is activated by a switch at the driver seat controls.

3. Dual movable blade windshield wiper as described in claim 1 or 2, where the pressure of the additional blade against the windshield is increased when activating the deep cleaning function.

4. Dual movable blade windshield wiper as described in claim 3, where the additional blade is integrated into the spoiler and it is hold to the jointed bows of the conventional blade.

5. Dual movable blade windshield wiper as described in claim 3, where the conventional blade is hold by a curved metal band (as per patent U.S. Pat. No. 3,192,551), being the joining elements of additional and conventional blade fixed to this metal band to enable relative movement between both blades.

6. Dual movable blade windshield wiper as described in claim 4 or 5, where the additional blade is easily exchangeable by a spare part.

7. Dual movable blade windshield wiper as described in claim 6 where the additional blade has two assembly positions and incorporates an ice scratcher in one side. Basic position, for weather seasons where there is no frost and there are flying insects. Alternative position for weather seasons where there are no flying insects but frost:

8. Dual movable blade windshield wiper as described in claim 7 where the water nozzles are located and distributed along the blades.

9. Dual movable blade windshield wiper as described in claim 7 and 8 where the abrasive material is a glass scratch free scourer or brush.
